(19) United States
(12) Patent Application Publication
(10) Pub. No.: US 2025/0385559 A1
(43) Pub. Date: Dec. 18, 2025

(54) MOTOR

(71) Applicant: DENSO CORPORATION, Kariya-city (JP)

(72) Inventors: Daisuke YATO, Kariya-city (JP); Yoshiyasu INOUE, Kariya-city (JP); Yohei KONNO, Kariya-city (JP); Kengo SATO, Kariya-city (JP)

(21) Appl. No.: 19/303,803

(22) Filed: Aug. 19, 2025

Related U.S. Application Data
(63) Continuation of application No. PCT/JP2023/043351, filed on Dec. 4, 2023.

(30) Foreign Application Priority Data
Feb. 22, 2023 (JP) 2023-026589

(51) Int. Cl. H02K 1/30; H02K 21/22

(52) U.S. Cl. CPC H02K 1/30; H02K 21/22

(57) ABSTRACT

A motor includes a shaft, a stator mounted coaxially with the shaft, a rotor yoke arranged around the stator, and a support member which mechanically support the rotor yoke to the shaft. The support member includes an opposing portion which faces the rotor yoke in a radial direction of the rotor yoke. The rotor yoke has an opposing surface which faces the opposing portion and has formed therein a groove in which adhesive is disposed to bond the opposing portion and the opposing surface together.

### CROSS REFERENCE TO RELATED DOCUMENT

The present application claims the benefit of priority of Japanese Patent Application No. 2023-026589 filed on Feb. 22, 2023, the disclosure of which is incorporated in its entirety herein by reference.

### TECHNICAL FIELD

This disclosure generally relates to a motor.

### BACKGROUND ART

As an example of a motor, the following configuration is known. Specifically, Japanese Unexamined Patent Application Publication No. 2021-020633 discloses a motor comprising: a shaft; a stator provided coaxially with the shaft; a rotor yoke provided around the stator; and a support member that mechanically supports the rotor yoke with respect to the shaft. The support member includes an opposing portion that faces the rotor yoke in a radial direction of the rotor yoke.

As a result of extensive studies by the inventors, it has been found that, in the above-described motor, there may be a demand to achieve both a reduction in weight of the support member and the assurance of rigidity of the support member. Furthermore, as a result of detailed investigation by the inventors, it has also been found that, when a surface of the rotor yoke that faces the opposing portion of the support member is bonded to the opposing portion using an adhesive, there may be a need to suppress strain in the adhesive.

### SUMMARY

The present disclosure has been made in view of the foregoing problems, and an object thereof is to provide, as one example, a motor capable of achieving both a reduction in weight of the support member and ensuring the rigidity of the support member, while also suppressing strain in the adhesive.

According to one aspect of this disclosure, there is provided a motor which comprises: (a) a shaft; (b) a stator which is arranged coaxially with the shaft; (c) a rotor yoke which is disposed around the stator; and (d) a support member which mechanically supports the rotor yoke to the shaft. The support member includes an opposing portion which faces the rotor yoke in a radial direction of the rotor yoke. The rotor yoke has an opposing surface which faces the opposing portion of the support member and has formed therein a groove in which adhesive is disposed to bond the opposing portion and the opposing surface together.

The above aspect of this disclosure provides the motor which enables the support member to be reduced in weight, ensures a required degree of rigidity of the support member, and minimizes strain on the adhesive.

### BRIEF DESCRIPTION OF THE DRAWINGS

In the drawings:

FIG. 1 is a longitudinal sectional view of a motor according to the first embodiment;

FIG. 2 is a perspective view of a support member according to the first embodiment;

FIG. 3 is a perspective view of a rotor yoke according to the first embodiment;

FIG. 4 is a perspective view illustrating a state in which a plurality of rotor magnets are provided on an inner circumferential surface of a rotor yoke according to the first embodiment;

FIG. 5 is an explanatory view illustrating a positional relationship among an opposing portion of a support member, a groove of a rotor yoke, and a plurality of rotor magnets according to the first embodiment;

FIG. 6 is an enlarged view illustrating a part of a rotor yoke according to the first embodiment;

FIG. 7 is a schematic cross-sectional view of a part of a rotor according to the first embodiment, in which dimensions of respective components are exaggerated;

FIG. 8 is a perspective view of a rotor yoke according to a second embodiment;

FIG. 9 is a cross-sectional view taken along line F9-F9 in FIG. 8;

FIG. 10 is a cross-sectional view taken along line F10-F10 in FIG. 8;

FIG. 11 is a plan view illustrating a state in which a plurality of rotor magnets are provided on an inner circumferential surface of a rotor yoke according to the second embodiment;

FIG. 12 is an explanatory view illustrating a positional relationship among an opposing portion of a support member, a groove of a rotor yoke, and a plurality of rotor magnets according to the second embodiment;

FIG. 13 is a view illustrating modified examples of a plurality of contact portions according to the second embodiment;

FIG. 14 is a perspective view of a rotor yoke according to a third embodiment;

FIG. 15 is a plan view illustrating a state in which a plurality of rotor magnets are provided on an inner circumferential surface of a rotor yoke according to the third embodiment;

FIG. 16 is an explanatory view illustrating a positional relationship among an opposing portion of a support member, grooves of a rotor yoke, and a plurality of rotor magnets according to the third embodiment;

FIG. 17 is a schematic cross-sectional view of a part of a rotor according to a fourth embodiment, in which dimensions of respective components are exaggerated;

FIG. 18 is an explanatory view illustrating a positional relationship among an opposing portion of a support member, a groove of a rotor yoke, and a plurality of rotor magnets according to the fourth embodiment;

FIG. 19 is a view illustrating a modified example of a rotor according to the fourth embodiment;

FIG. 20 is a perspective view of a rotor yoke according to a fifth embodiment;

FIG. 21 is a schematic cross-sectional view of a part of a rotor according to the fifth embodiment, in which dimensions of respective components are exaggerated;

FIG. 22 is a plan view illustrating a state in which a plurality of rotor magnets are provided on an inner circumferential surface of a rotor yoke according to the fifth embodiment;

FIG. 23 is an explanatory view illustrating a positional relationship among contact portions, grooves of a rotor yoke, and a plurality of rotor magnets according to the fifth embodiment;

FIG. 24 is a perspective view of a rotor yoke according to a sixth embodiment;

FIG. 25 is a perspective view of a rotor yoke according to a seventh embodiment;

FIG. 26 is a schematic cross-sectional view of a part of a rotor according to an eighth embodiment, in which dimensions of respective components are exaggerated;

FIG. 27 is an explanatory view illustrating a positional relationship among an opposing portion of a support member, grooves of a rotor yoke, and a plurality of rotor magnets according to a ninth embodiment;

FIG. 28 is a view illustrating a modified example of grooves according to the ninth embodiment; and

FIG. 29 is a schematic cross-sectional view of a rotor according to a comparative example, in which dimensions of respective components are exaggerated.

### MODE FOR CARRYING OUT THE INVENTION

### First Embodiment

The first embodiment in this disclosure will be described below.

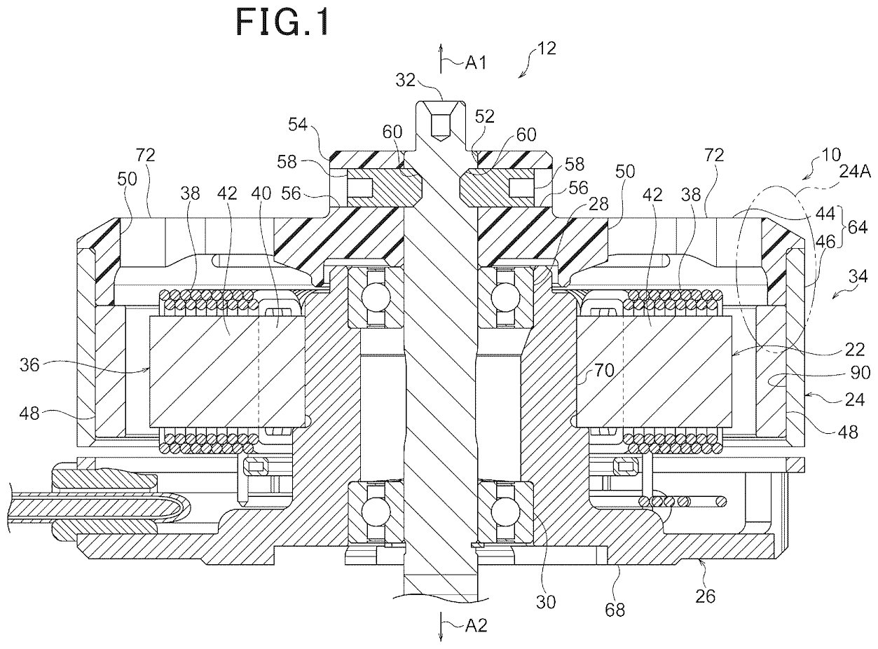

FIG. 1 is a cross sectional view of the electrical motor 10 according to the first embodiment. The motor 10 is of an outer-rotor brushless motor and includes the stator 22, the rotor 24, the base member 26, the first ball bearing 28, the second ball bearing 30, and the shaft 32. The motor 10 has a first end (which will also be referred to below as a first side or a first axial side) and a second end (which will also be referred to below as a second side or a second axial side) opposed to the first end in an axial direction thereof. The first end faces in the first axial direction A1, while the second end faces in the axial direction A2 (also referred to below as a second axial direction).

The stator 22, the rotor 24, and the base member 26 define the motor body 34. The stator 22 is of an annular shape and arranged coaxially with the shaft 32. The stator 22 includes the stator core 36 and a plurality of winding coils 38. The stator core 36 includes the annular body 40 and a plurality of teeth 42 which radially extend from the circumference of the annular body 40. Each of the teeth 42 has an electrical insulator (not shown) fit thereon. A conductor is wound around each of the teeth 42 through the insulator, thereby forming the winding coils 38 on the teeth 42.

The rotor 24 includes the support member 44, the rotor yoke 46, and a plurality of rotor magnets 48. The rotor yoke 46 is made from material which is lower in coefficient of thermal expansion than that of the support member 44. For instance, the support member 44 is made from resin, while the rotor yoke 46 is made from iron.

The support member 44 is arranged on the first side of the stator 22 and faces the stator 22 in the axial direction thereof. The support member 44 has formed in a central portion thereof the through-hole 52 which extends through the support member 44 in the axial direction. The shaft 32 is inserted into the through-hole 52. The support member 44 has a first end facing in the axial direction A1 (also referred to below as a first axial direction). The support member 44 has formed on a central portion of the first end thereof the protrusion 54 in the form of a boss. The protrusion 54 protrudes in the axial direction of the support member 44 and has a plurality of screw holes 56 which extend in a radial direction of the support member 44.

Each of the screw holes 56 passes through the through-hole 52. The screw holes 56 have the set screws 58 (also called grub screws) threaded thereinto. The shaft 32 has a plurality of recesses 60 formed therein. A head of each of the set screws 58 engages or is fit in a respective one of the recesses 60, thereby firmly securing the rotor 34 to the shaft 32.

The rotor yoke 46 (i.e., a back yoke) is of an annular shape and arranged on the overall circumference of the stator 22. The rotor yoke 46 is secured to the outer circumference of the support member 44, so that it is retained by the shaft 32 through the support member 44. The support member 44 and the rotor yoke 46 define the rotor housing 64 which is of a cylindrical shape with a bottom end or a top end. The stator 22 is disposed inside the rotor housing 64 to be rotatable.

The inner peripheral surface 90 of the rotor yoke 46 has a plurality of rotor magnets 48 mounted thereon. The rotor magnets 48 are arranged adjacent to each other in the circumferential direction of the rotor yoke 46. Each of the rotor magnets 48 faces a respective one of the teeth 42 of the stator 22 in the radial direction of the motor 10. An adjacent respective two of the rotor magnets 48 have magnetic polarities different from each other.

The base member 26 that is in the shape of a center piece includes the disc 68 and the bearing housing 70. The disc 68 is arranged on the second side (i.e., the second side of the motor 10 facing in the axial direction A2) of the of the stator 22 and faces the stator 22 in the axial direction of the stator 22. The bearing housing 70 protrudes from the disc 68 toward the stator 22. The bearing housing 70 is press-fit in the annular body 40 of the stator core 36, thereby retaining the stator 22 by the bearing housing 70. The bearing housing 70 is of a hollow cylindrical shape and has openings facing in opposite axial directions of the base member 26.

The bearing housing 70 has disposed therein the first ball bearing 28 and the second ball bearing 30 which are spaced apart from each other in the axial direction of the bearing housing 70. The shaft 32 is inserted into the first ball bearing 28 and the second ball bearing 30. The shaft 32 is mechanically supported by the first ball bearing 28 and the second ball bearing 30 to be rotatable.

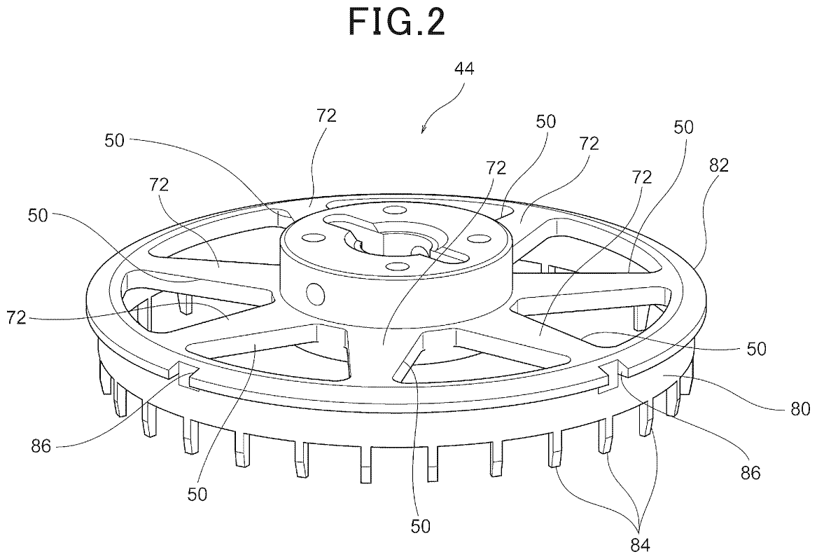

FIG. 2 is a perspective view which illustrates the support member 44 in the first embodiment. The support member 44 has the lightening holes (also called weight reduction holes) 50 which pass through the thickness of the support member 44 in the axial direction. The lightening holes 50 are arranged at equal intervals away from each other in the circumferential direction of the support member 44, thereby defining a plurality of spokes 72 extending radially from the center of the support member 44.

An outer circumference of the support member 44 is mechanically retained by the center of the support member 44 through the spokes 72. The outer circumference of the support member 44 includes the opposing portion 80, the stopper 82, and a plurality of positioners 84. The opposing portion 80 is of an annular shape and extends in the circumferential direction of the support member 44.

The stopper 82 is located closer to the first end of the support member 44 than the opposing portion 80 is in the axial direction of the support member 44. The stopper 82 protrudes outside the opposing portion 80 in a radially outward direction of the support member 44. The stopper 82 is annular in shape and extends in the circumferential direction of the support member 44. The stopper 82 has a plurality of positioning recesses 86 formed therein. Each of the positioning recesses 86 is concave in the shape of a cavity and has an opening facing in the radially outward direction of the support member 44. Each of the positioning recesses 86 passes through the thickness of the support member 44 in the axial direction of the support member 44.

The positioners 84 are spaced apart from each other in the circumferential direction of the support member 44. Each of the positioners 84 extends from the opposing portion 80 in the second axial direction of the support member 44 (i.e., the axial direction A2). Each of the positioners 84 is arranged between a respective adjacent two of the rotor magnets 48 (see FIG. 1). The positioners 84 function to position the rotor magnets 48.

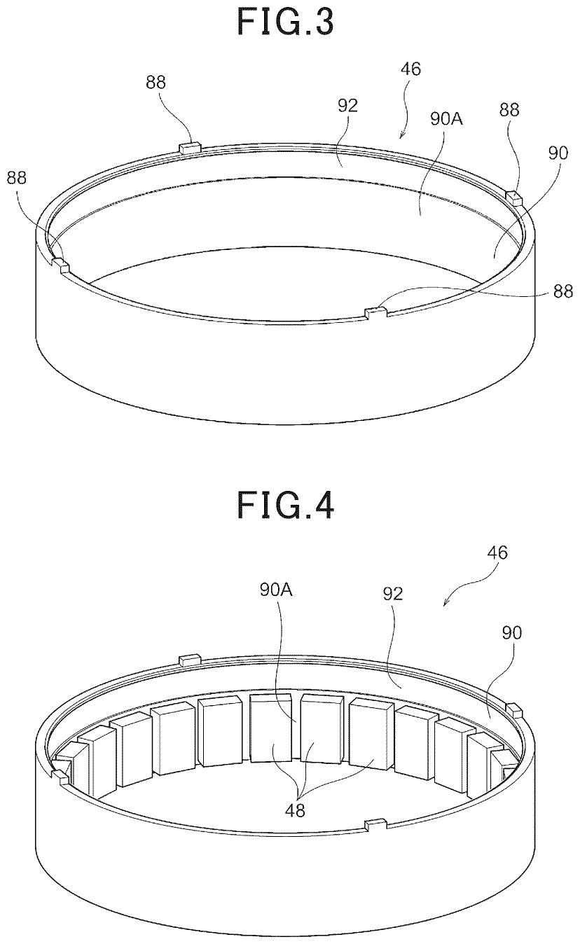

FIG. 3 is a perspective view of the rotor yoke 46 according to the first embodiment. The rotor yoke 46 has a plurality of positioning protrusions 88 formed on one of axially opposed ends thereof which faces in the first axial direction A1. Each of the positioning protrusions 88 extends outside the end of the rotor yoke 46 in the axial direction of the rotor yoke 46. Each of the positioning protrusions 88 engages a respective one of the positioning recesses 86 (see FIG. 2) to position the rotor yoke 46 in the circumferential direction of the support member 44. The rotor yoke 46 has the inner peripheral surface 90 which includes the bonding surface 90A to which the rotor magnets 48 are bonded (see FIG. 1).

The rotor yoke 46 has the groove 92 formed in the inner peripheral surface 90 thereof. The groove 92 is located closer to the first axial end of the rotor yoke 46 than the bonding surface 90A is. Each of the bonding surface 90A and the groove 92 is of an annular shape and extends in the circumferential direction of the rotor yoke 46. The groove 92 may be formed by machining or cutting techniques after the rotor yoke 46 is formed into an annular shape. The formation of the rotor yoke 46 may alternatively be achieved by pressing a plate to make the groove 92 in the plate and then bending the plate into an annular shape.

FIG. 4 is a perspective view which illustrates the rotor yoke 46 which has the rotor magnets 48 attached to the inner peripheral surface 90. Specifically, the rotor magnets 48 are adhered to the bonding surface 90A of the rotor yoke 46. A respective adjacent two of the rotor magnets 48 are arranged at a given interval away from each other in the circumferential direction of the rotor yoke 46. The groove 92 is located closer to the first axial end of the rotor yoke 46 than the bonding surface 90A is. After the rotor magnets 48 are firmly attached to the bonding surface 90A, the groove 92 is located closer to the first axial end of the rotor yoke 46 than the rotor magnets 48 are.

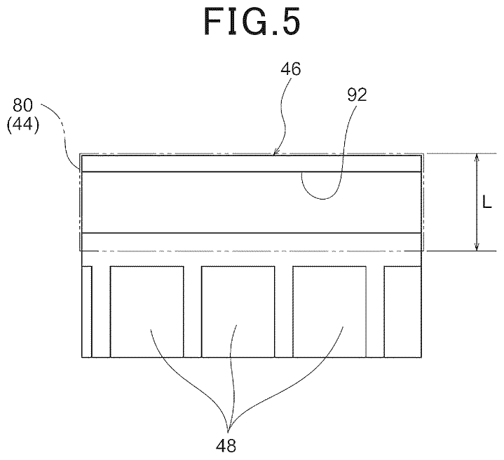

FIG. 5 represents a positional relation among the opposing portion 80 of the support member 44, the groove 92 of the rotor yoke 46, and the rotor magnets 48. FIG. 5 is a planar development showing the opposing portion 80, the rotor yoke 46, and the rotor magnets 48. The groove 92 lies within a range Z that is a dimension (i.e., width) of the opposing portion 80 in the axial direction of the support member 44. The opposing portion 80 of the support member 44 is located closer to the first axial end of the rotor yoke 46 than the rotor magnets 48 are.

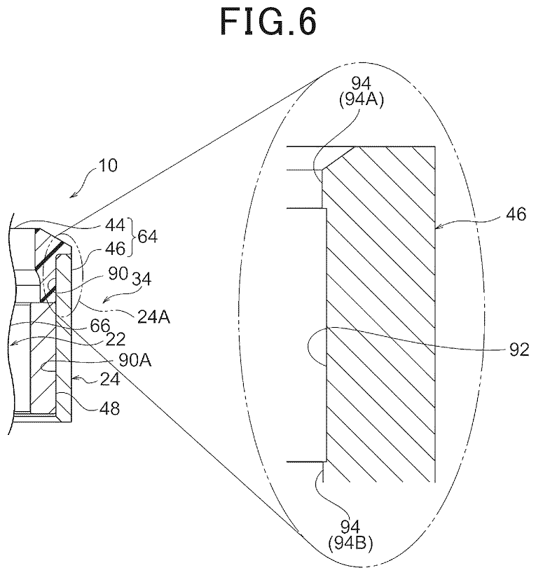

FIG. 6 is a partially enlarged view of the rotor yoke 46 in the first embodiment. The rotor yoke 46 has the contact portions 94 formed on the inner peripheral surface 90. The contact portions 94 include the first contact portion 94A and the second contact portion 94B. The first contact portion 94A and the second contact portion 94B are located away from each other across the groove 92 in the axial direction of the rotor yoke 46. Specifically, the first contact portion 94A is arranged closer to the first axial end of the rotor yoke 46 than the groove 92 is in the axial direction of the rotor yoke 46, while the second contact portion 94B is arranged closer to the second axial end of the rotor yoke 46 than the groove 92 is in the axial direction of the rotor yoke 46. Each of the first contact portion 94A and the second contact portion 94B is of an annular shape and extends in the circumferential direction of the rotor yoke 46.

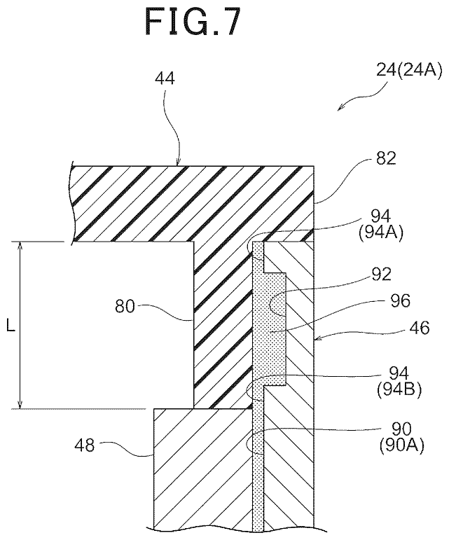

FIG. 7 is a schematic cross-sectional view, with dimensions of each component exaggerated, illustrating the portion 24A of the rotor 24 according to the first embodiment. The adhesive 96 is applied to the inner peripheral surface 90 of the rotor yoke 46. The inner peripheral surface 90 of the rotor yoke 46 is bonded to the opposing portion 80 of the support member 44 through the adhesive 96. In the state where the inner peripheral surface 90 is bonded to the opposing portion 80, the opposing portion 80 is positioned radially inward of the rotor yoke 46 and faces the inner peripheral surface 90 of the rotor yoke 46 in the radial direction of the rotor yoke 46. The inner peripheral surface 90 is one example of an opposing surface in the present disclosure. The adhesive 96 has a portion accommodated in the groove 92. This enables the volume of the adhesive 96 to be increased as compared to a case where the groove 92 is omitted, thereby enhancing the bonding strength between the opposing portion 80 and the inner peripheral surface 90.

The stopper 82 abuts the rotor yoke 46 from the first axial side of the support member 44, thereby positioning the rotor yoke 46 in the axial direction of the support member 44. The abutment of the stopper 82 with the rotor yoke 46 will also minimize a risk that the rotor yoke 46 may tilt toward or lean against the opposing portion 80 in the event that an external disturbance acts on the rotor yoke 46, or during an assembly operation in which the rotor yoke 46 is mounted onto the support member 44. The stopper 82 may be spaced apart from the rotor yoke 46 in the axial direction of the support member 44.

The adhesive 96 also occupies both sides of the groove 92 which are opposed to each other in the axial direction of the rotor yoke 46. The first contact portion 94A and the second contact portion 94B are bonded to the opposing portion 80 of the support member 44 through the adhesive 96. The first contact portion 94A and the second contact portion 94B are, therefore, in contact with the opposing portion 80 in the radial direction of the rotor yoke 46 through the adhesive 96. The first contact portion 94A and the second contact portion 94B may alternatively directly contact the opposing portion 80 without the adhesive 96. In other words, the rotor yoke 46 may be fitted to the opposing portion 80 at the first contact portion 94A and the second contact portion 94B.

The adhesive 96 also occupies the bonding surface 90A. Each of the rotor magnets 48 is attached to the bonding surface 90A through the adhesive 96. In the state where the rotor magnets 48 are secured to the bonding surface 90A, the groove 92 is located closer to the first axial end of the rotor yoke 46 than the rotor magnets 48 are in the axial direction of the rotor yoke 46. The opposing portion 80 contacts the rotor magnets 48 from the first axial side of the rotor yoke 46. The opposing portion 80 of the support member 44 may alternatively be arranged away from the rotor magnets 48 in the axial direction of the rotor yoke 46.

A comparative example will be described below. FIG. 29 is a schematic cross-sectional view, with dimensions of each component exaggerated, illustrating a portion of a rotor in the comparative example. The rotor has the groove 92 formed on the outer peripheral surface of the opposing portion 80, rather than on the inner peripheral surface 90 of the rotor yoke 46. The formation of the groove 92 on the outer peripheral surface of the opposing portion 80 will result in decrease in rigidity of the opposing portion 80, i.e., the support member 44. The support member 44 is formed of resin, while the rotor yoke 46 is formed of iron, such that the support member 44 has a higher coefficient of thermal expansion than the rotor yoke 46.

Therefore, when the groove 92 is formed on the outer peripheral surface of the opposing portion 80, there is a possibility that the strain of the adhesive 96 accommodated in the groove 92 may increase in environments with significant temperature fluctuations.

In contrast to the above structure, the grove 92 in the first embodiment (see FIG. 7) is, as described above, formed in the inner peripheral surface 90 of the rotor yoke 46 and not in the opposing portion 80. This ensures a required degree of rigidity of the opposing portion 80, consequently, the support member 44 as compared to the case to the structure in which the groove 92 is formed in the opposing portion 80 as in the comparative example. The structure in the first embodiment, therefore, ensures a required degree of rigidity of the support member 44 even in a case where the support member 44 is weight-reduced by providing cut-out portions between the plurality of spokes 72 (see FIG. 2). This achieves both weight reduction of the support member 44 and securing of the rigidity of the support member 44.

Further, in the first embodiment, the groove 92 is formed in the rotor yoke 46, which has a lower coefficient of thermal expansion than the support member 44. Accordingly, even in environments with significant temperature variations, it is possible to suppress strain in the adhesive 96 accommodated in the groove 92, as compared to the comparative example.

Further, in the first embodiment, the groove 92 is located at a position axially offset from the rotor magnets 48 of the rotor yoke 46. This ensures a required thickness of a portion of the rotor yoke 46 which creates a magnetic circuit as compared with a case where the groove 92 is located in alignment with the rotor magnets 48 in the radial direction of the rotor yoke 46. This ensures required magnetic characteristics of the motor 10 and the rigidity of the rotor yoke 46 required to support the rotor magnets 48.

The groove 92 is formed annularly along the circumferential direction of the rotor yoke 46. This enables the center of gravity of the rotor yoke 46 to be aligned with the center of the rotational axis of the rotor yoke 46, thereby ensuring rotational balance of the rotor 24. The annular shape of the groove 92 also facilitates the ease with which the groove 92 is machined in the support member 44.

The groove 92 is, as described above, formed within the range L whose dimension in the axial direction of the support member 44 is equal to a dimension or width of the opposing portion 80 in the axial direction of the support member 44. This enables a required degree of strength of bonding of the rotor yoke 46 to the support member 44 to be ensured with a smaller volume of the adhesive 96 than when the groove 92 is formed to extend beyond the range L of the opposing portion 80.

The rotor yoke 46, as described above, has formed on the inner peripheral surface 90 the contact portions 94 placed in mechanical contact with the opposing portion 80 in the radial direction of the rotor yoke 46. Such contact of the contact portions 94 with the rotor yoke 46 minimizes a risk that the rotor yoke 46 may tilt toward or lean against the opposing portion 80 in the event that an external disturbance acts on the rotor yoke 46, or during an assembly operation in which the rotor yoke 46 is mounted onto the support member 44. This enables the center of gravity of the rotor yoke 46 to be aligned with the center of the rotational axis of the rotor yoke 46, thereby ensuring the rotational balance of the rotor 24.

The contact portions 94, as described above, includes the first contact portion 94A, which is formed closer to first axial side of the rotor yoke 46 than respect to the groove 92 is, and the second contact portion 94B, which is formed closer to the second axial side of the rotor yoke 46 than the groove 92 is. This also minimizes the risk that the rotor yoke 46 may tilt or lean against the opposing portion 80, as compared to a case in which the rotor yoke 46 is shaped to have only one of the first contact portion 94A and the second contact portion 94B.

The contact portions 94 are located at positions offset from the groove 92 in the axial direction of the rotor yoke 46. This enables the cross-sectional shape of the groove 92 to be made constant in the circumferential direction of the groove 92, thereby facilitating the machining of the groove 92.

The offset locations of the contact portions 94 from the rotor magnets 48 in the axial direction of the rotor yoke 46 also ensure the physical contact between the contact portions 94 and the opposing portion 80 without mechanical interference between the contact portions 94 and the rotor magnets 48.

The contact portions 94 are, as described above, formed in an annular shape along the circumferential direction of the rotor yoke 46.

This enables the center of gravity of the rotor yoke 46 to be aligned with the center of the rotational axis of the rotor yoke 46, thereby ensuring required rotational balance of the rotor 24. The annular shape of the contact portions 94 contributes to improved machinability of the groove 92.

The opposing portion 80 is positioned radially inward of the rotor yoke 46. This enables the support member 44 to be shaped to have a minimized dimension in the radial direction of the support member 44, thereby resulting in a compact size of the motor 10 in the radial direction thereof.

### Second Embodiment

The second embodiment in this disclosure will be described below.

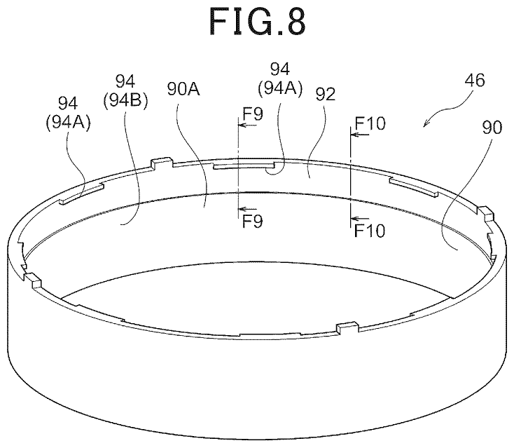

The second embodiment is different in structure described below from the first embodiment. FIG. 8 is a perspective view of the rotor yoke 46 according to the second embodiment. The rotor yoke 46 has the inner peripheral surface 90 on which a plurality of first contact portions 94A are formed. The plurality of first contact portions 94A are formed to have the same shape as each other. The first contact portions 94A are arranged at equal intervals away from each other in the circumferential direction of the rotor yoke 46. The first contact portions 94A constitute one example of the contact portions according to the present disclosure. The second contact portion 94B is formed in an annular shape along the circumferential direction of the rotor yoke 46.

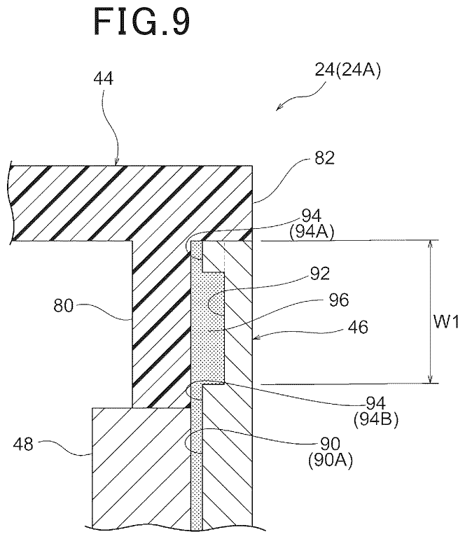

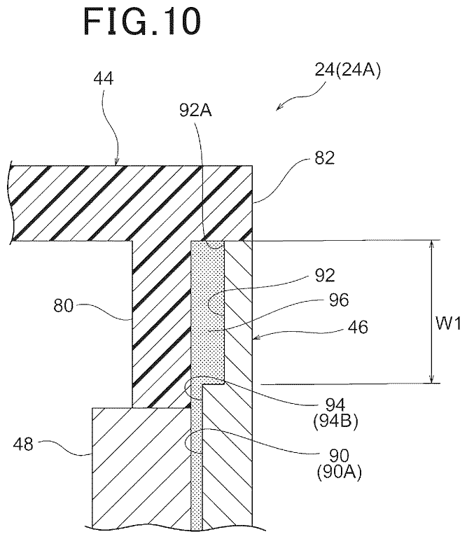

FIG. 9 is a cross-sectional view taken along line F9-F9 of FIG. 8 (i.e., a cross-section at the position of one of the first contact portions 94A). FIG. 10 is a cross-sectional view taken along line F10-F10 of FIG. 8 (i.e., a cross-section at a position offset from one of the first contact portions 94A). FIGS. 9 and 10 are schematic cross-sectional views that illustrate the respective portions of FIG. 8 with dimensions exaggerated for clarity. Here, the axial direction of the rotor yoke 46 is defined as the width direction of the groove 92. Each of the first contact portions 94A is formed at a position that falls within a width range W1 of the groove 92. Specifically, each of the contact portions 94 is formed on one of sides of the groove 92 which are opposed to each other in the width direction of the groove 92. In other words, each of the contact portions 94 is located adjacent to one (which will also be referred to below as a first side) of the sides of the width of the groove 92 which faces the first axial end of the rotor yoke 46. The groove 92, as can be seen in FIG. 10, has openings 92A each of which lies between a respective adjacent two of the first contact portions 94A and is oriented in the first axial direction of the rotor yoke 46.

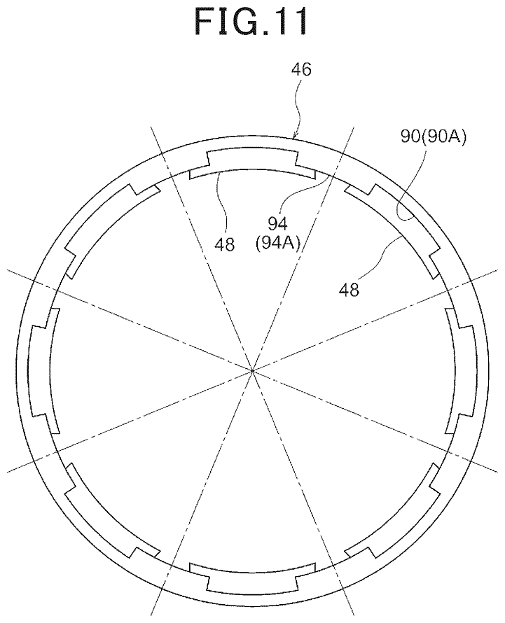

FIG. 11 is a plan view showing a state in which the plurality of rotor magnets 48 are provided on the inner peripheral surface 90 of the rotor yoke 46 according to the second embodiment. Each of the first contact portions 94A is formed in an arcuate shape along the circumferential direction of the rotor yoke 46 in a plan view of the rotor yoke 46.

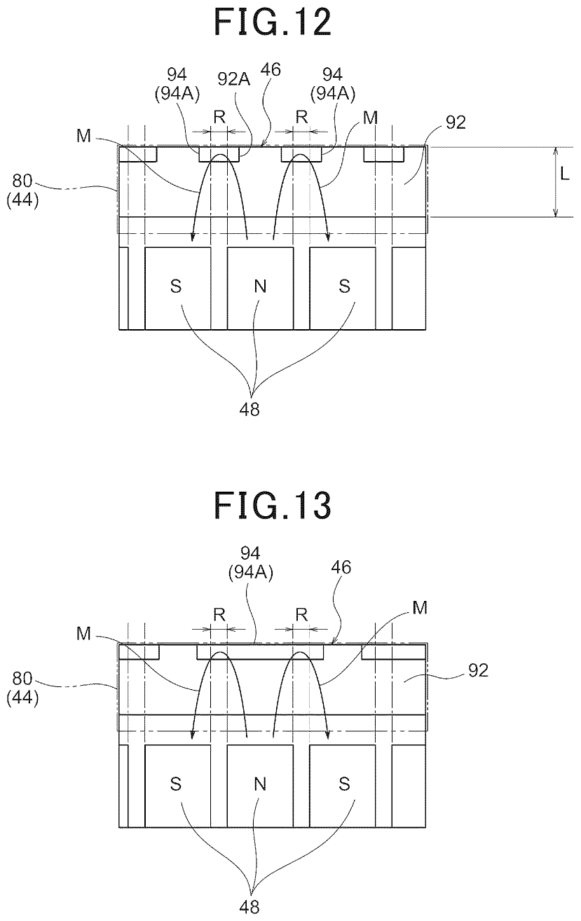

FIG. 12 is an explanatory diagram which illustrates the positional relationship among the opposing portion 80 of the support member 44, the groove 92 of the rotor yoke 46, and the rotor magnets 48 according to the second embodiment. In FIG. 12, the opposing portion 80, the rotor yoke 46, and the plurality of rotor magnets 48 are shown in a planarly developed state. Each of the first contact portions 94A is positioned within the range L which corresponds to a dimension (i.e., the width) of the opposing portion 80 of the support member 44, as measured in the axial direction of the rotor yoke 46. Each of the first contact portions 94A extends in the circumferential direction of the rotor yoke 46 over a range R that is defined by an interval between a respective adjacent two of the rotor magnets 48 in the circumferential direction of the rotor yoke 46. For instance, the number of first contact portions 94A is equal to the number of rotor magnets 48. Each of the first contact portions 94A is aligned with a respective one of the ranges R in the axial direction of the rotor yoke 46. The rotor yoke 46 creates therein magnetic flux paths M along each of which magnetic flux flows from one to the other of a respective adjacent two of the rotor magnets 48. Each of the first contact portions 94A is located in a respective one of the magnetic flux paths M.

The rotor yoke 46 in the second embodiment is configured to have the plurality of first contact portions 94A formed away from each other in the circumferential direction of the rotor yoke 46. In other words, a portion of the rotor yoke 46 between a respective adjacent two of the first contact portions 94A is omitted, thereby resulting in a decreased weight of the rotor yoke 46 as compared with a case where the rotor yoke 46 has a single first contact portion 94A of an annular shape extending along the entire circumference of the rotor yoke 46.

Each of the first contact portions 94A is, as described above, arranged to extend over the range R between a respective adjacent two of the rotor magnets 48. This compensates for a lowered rigidity of a portion of the rotor yoke 46 between adjacent two of the rotor magnets 48, thereby ensuring a required degree of overall rigidity of the rotor yoke 46.

The first contact portions 94A are formed to have the same shape as one another and are arranged at equal intervals away from each other in the circumferential direction of the rotor yoke 46. This enables the center of gravity of the rotor yoke 46 to be aligned with the center of the rotational axis of the rotor yoke 46, thereby ensuring required rotational balance of the rotor 24.

Each of the first contact portions 94A is, as described above, located in a corresponding one of the magnetic flux paths M each of which is defined by a respective adjacent two of the rotor magnets 48. In other words, a thick wall of each of the first contact portions 94A forms a part of a corresponding one of the magnetic flux paths M, thereby enhancing magnetic characteristics of the motor 10 as compared with a case in which the first contact portions 94A are positioned outside the magnetic flux paths M.

The groove 92, as described already, has the openings 92A each of which lies between a respective adjacent two of the first contact portions 94A and faces in the first axial direction of the rotor yoke 46. This results in an increased with of each portion of the groove 92 which is located between a respective adjacent two of the first contact portions 94A. The configuration of the groove 92 having the openings 92A also enables the amount of the adhesive 96 between the adjacent first contact portions 94A to be increased as compared with a case where each portion of the rotor yoke 46 between a respective adjacent two of the first contact portions 94A is closed in the first axial direction of the rotor yoke 46, thereby increasing the mechanical strength of adhesion between the opposing portion 80 and the inner peripheral surface 90 of the rotor yoke 46.

FIG. 13 is a diagram which shows a modified form of the contact portions 94 according to the second embodiment. Each of the contact portions 94 (i.e., the first contact portions 94A) is shaped to have a length which extends in the circumferential direction of rotor yoke 46 and spans multiple ranges R (two ranges R in the illustrated example). Each of the ranges R is, as described above, an interval between a respective adjacent two of the rotor magnets 48 in the circumferential direction of the rotor yoke 46. The layout of the contact portions 94 in this modification provides substantially the same beneficial effects as those offered by the structure illustrated in FIG. 12.

### Third Embodiment

The third embodiment in this disclosure will be described below.

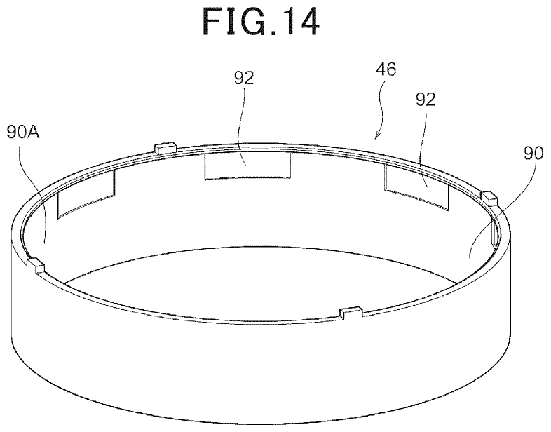

The third embodiment is different in structure described below from the first embodiment. FIG. 14 is a perspective view of the rotor yoke 46 according to the second embodiment. The rotor yoke 46 has the inner peripheral surface 90 on which a plurality of grooves 92 are formed. The grooves 92 are identical in configuration with each other. The grooves 92 are arranged at equal intervals away from each other in the circumferential direction of the rotor yoke 46. Each of the groove 92 is shaped to have a length extending in the circumferential direction of the rotor yoke 46. The number of the groove 92 may be set as desired.

FIG. 15 is a plan view which illustrates the rotor yoke 46 in the third embodiment. The rotor yoke 46 has the inner peripheral surface 90 to which the rotor magnets 48 are attached. Each of the grooves 92 lies within a corresponding one of width ranges W2 each of which is identical with a respective one of the rotor magnets 48, as measured in the circumferential direction of the rotor yoke 46.

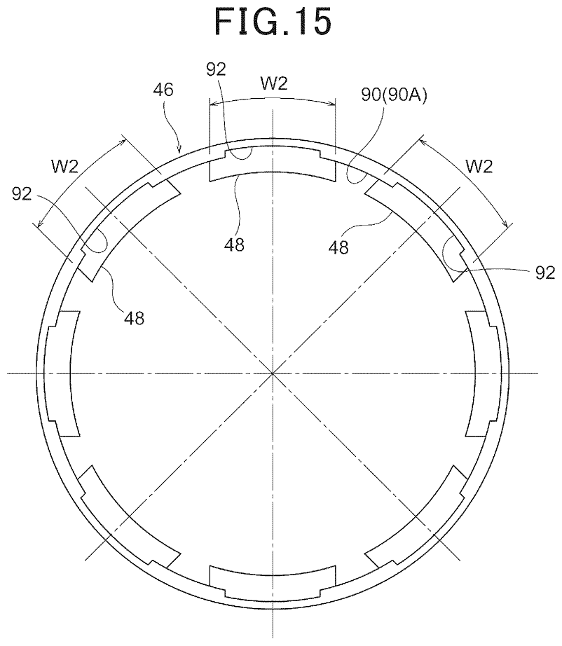

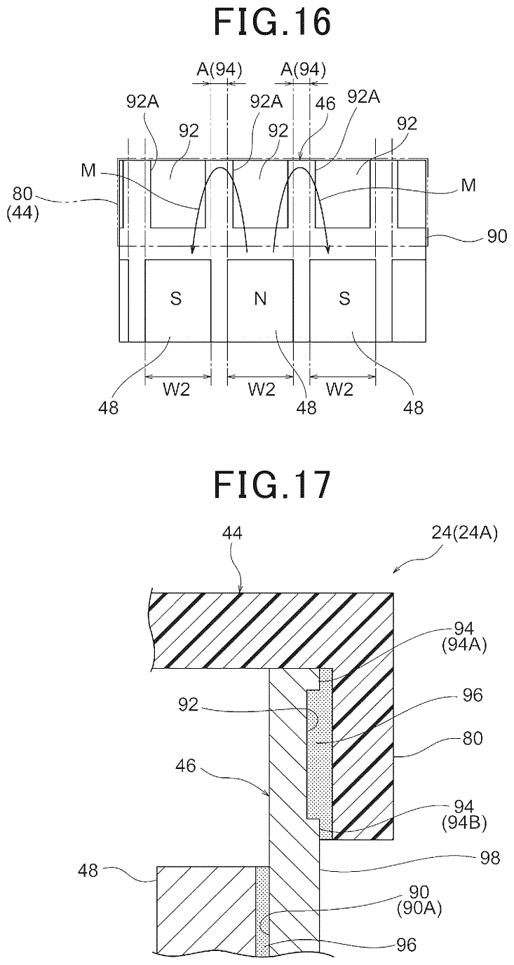

FIG. 16 is an explanatory diagram illustrating the positional relationship among the opposing portion 80 of the support member 44, the grooves 92 of the rotor yoke 46, and the plurality of rotor magnets 48 according to the third embodiment. FIG. 16 illustrates the opposing portion 80, the rotor yoke 46, and the plurality of rotor magnets 48 in a planar developed view. Each of the grooves 92 opens on the first axial side of the rotor yoke 46. Specifically, each of the grooves 92 has the opening 92A which faces in the first axial direction of the rotor yoke 46. Each of the grooves 92 has a closed end facing in the second axial direction of the rotor yoke 46.

The rotor yoke 46 creates therein the magnetic flux paths M each of which extends from one to the other of a respective adjacent two of the rotor magnets 48. An area between a respective adjacent two of the grooves 92 on the inner peripheral surface 90 is defined as the region A. Each of the regions A is located substantially in coincidence with a corresponding one of the magnetic flux paths M which extends between two of the rotor magnets 48 which are located adjacent to the corresponding region A in the circumferential direction of the rotor yoke 46. Each of the regions A serves as the contact portion 94.

In the third embodiment, the grooves 92 are formed adjacent to each other in the circumferential direction of the rotor yoke 46. This layout ensures an increased wall thickness of the rotor yoke 46 between the adjacent grooves 92, thereby enhancing the rigidity of the rotor yoke 46 as compared to a case where the single groove 92 is formed annularly in the circumferential direction of the rotor yoke 46.

The grooves 92 are formed in the same shape with respect to each other, and are arranged at equal intervals away from each other in the circumferential direction of the rotor yoke 46. This enables the center of gravity of the rotor yoke 46 to coincide with the center of the rotational axis of the rotor yoke 46, thereby ensuring required rotational balance of the rotor 24.

Each of the grooves 92 is located within the width range W2 of a corresponding one of the rotor magnets 48 in the circumferential direction of the rotor yoke 46. This layout enables the rotor magnets 48 to compensate for a reduction in rigidity caused by the formation of the grooves 92, thereby ensuring a required degree of rigidity of the rotor yoke 46.

Each of the regions A is, as described above, located substantially to occupy at least a portion of a corresponding one of the magnetic flux paths M which extends between two of the rotor magnets 48 which are located adjacent to the corresponding region A in the circumferential direction of the rotor yoke 46. Each of the regions A between the adjacent grooves 92, therefore, provides an increased wall thickness of the rotor yoke 46 which forms part of the corresponding magnetic flux path M, thereby enhancing the magnetic characteristics of the motor 10 as compared to a case where only thin-walled portions of the rotor yoke 46 arising from the formation of the grooves 92 coincide with the magnetic flux paths M.

The region A between each pair of adjacent grooves 92 works as the contact portion 94. This results in an increase in area of contact of each of the contact portions 94 with the opposing portion 80 as compared to a case in which the single groove 92 is formed annularly along the circumferential direction of the rotor yoke 46. This increases the rigidity of the rotor yoke 46 required to mechanically support the opposing portion 80. The contact portions 94 function as rigid portions between each pair of adjacent grooves 92, thereby enhancing the entire rigidity of the rotor yoke 46 as compared to a case in which the single annular groove 92 is formed in the circumference of the rotor yoke 46. Furthermore, the abutment of each of the contact portions 94 with the opposing portion 80 through the adhesive 96 results in an increase in mechanical strength of adhesion of the rotor yoke 46 to the opposing portion 80.

Each of the grooves 92 has the opening 92A that opens toward first axial side of the rotor yoke 46. This facilitates the ease with which the grooves 92 is formed in the inner peripheral surface 90 of the rotor yoke 46 as compared to a case in which each groove 92 is closed on first axial side of the rotor yoke 46 without having the opening 92A.

### Fourth Embodiment

The fourth embodiment in this disclosure will be described below.

The fourth embodiment is different in configuration discussed below, from the first embodiment. FIG. 17 is a schematic cross-sectional view illustrating, in an exaggerated manner, dimensions of the portion 24A of the rotor 24 according to the fourth embodiment. The rotor 24 in the fourth embodiment has the opposing portion 80 which is located radially outside the rotor yoke 46. The outer peripheral surface 98 of the rotor yoke 46 faces the opposing portion 80 in the radial direction of the rotor yoke 46. The outer peripheral surface 98 is one example of an opposing surface as referred to in the present disclosure. The rotor magnets 48 are firmly attached to the inner peripheral surface 90 of the rotor yoke 46 through the adhesive 96. The inner peripheral surface 90 is an example of a surface facing away from the opposing surface (i.e., the outer peripheral surface 98) in the present disclosure.

The rotor yoke 46 has the groove 92 formed in the outer peripheral surface 98 thereof. The groove 92 is located closer to the first axial side of the rotor yoke 46 than the bonding surface 90A and the rotor magnets 48 are. The rotor yoke 46 has the first contact portion 94A located closer to the first axial side of the rotor yoke 46 than the groove 92 is. The rotor yoke 46 also has the second contact portion 94B located closer to the second axial side of the rotor yoke 46 than the groove 92 is.

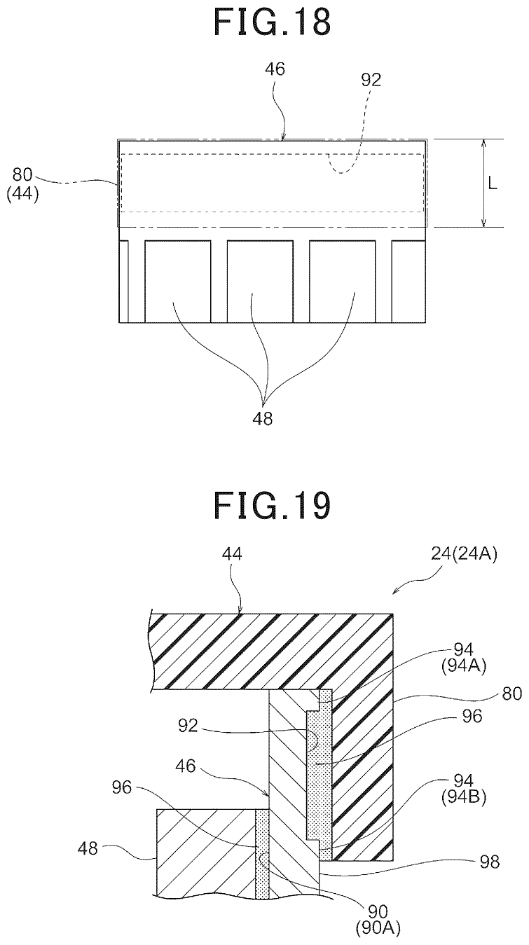

FIG. 18 is an explanatory diagram which illustrates the positional relationship among the opposing portion 80 of the support member 44, the groove 92 of the rotor yoke 46, and the plurality of rotor magnets 48 according to the fourth embodiment. FIG. 18 illustrates the opposing portion 80, the rotor yoke 46, and the plurality of rotor magnets 48 in a planar developed view. The groove 92 is shaped to have a width lying within the range Z corresponding to the width of the opposing portion 80, as measured in the axial direction of the support member 44. The opposing portion 80 is positioned closer to the first axial side of the rotor yoke 46 than the rotor magnets 48 are.

The rotor yoke 46 in the fourth embodiment is, as can be seen in FIG. 17, designed to have the groove 92 formed in the outer peripheral surface 98 thereof, not in the opposing portion 80. This results in an increased degree of rigidity of the opposing portion 80, i.e., the supporting member 44, as compared to when the groove 92 is formed in the opposing portion 80, thereby resulting both in a decrease in weight of and in an increase in rigidity of the support member 44 despite the support member 44 having the plurality of lightening holes 50 (see FIG. 2).

The groove 92 is formed in the rotor yoke 46 which is lower in coefficient of thermal expansion than the support member 44, thereby resulting in a decrease in strain of the adhesive 96 disposed in the groove 92 which usually arises from a great change in ambient temperature.

The groove 92 is offset from the rotor magnets 48 in the axial direction of the rotor yoke 46. This eliminates a risk that thicknesses of portions of the rotor yoke 46 which define magnetic circuits may be undesirably decreased by forming the groove 92 into alignment with the rotor magnets 48 in the radial direction of the rotor yoke 46. This ensures required magnetic characteristics of the motor 10 and a degree of rigidity of the rotor yoke 46 required to mechanically retain the rotor magnets 48.

The groove 92 is, as described above, located within the range L that is the width of the opposing portion 80, as measured in the axial direction of the support member 44. This ensures a required degree of mechanical strength of bonding of the rotor yoke 46 to the support member 44 with a decreased volume of the adhesive 46, as compared with the groove 92 is shaped to have a width over the range L, i.e., the width of the opposing portion 80.

The rotor yoke 46 has the contact portions 94 formed on the outer peripheral surface 98 thereof. The contact portions 94 make physical contacts with the opposing portion 80 in the radial direction of the rotor yoke 46. Such contact of the contact portions 94 with the opposing portion 80 minimizes a risk that the rotor yoke 46 may tilt or lean against the opposing portion 80 in the event that an external disturbance acts on the rotor yoke 46, or during an assembly operation in which the rotor yoke 46 is mounted onto the support member 44. This enables the center of gravity of the rotor yoke 46 to be aligned with the center of the rotational axis of the rotor yoke 46, thereby ensuring the rotational balance of the rotor 24.

The contact portions 94 include the first contact portion 94A and the second contact portion 94B. The first contact portion 94A and the second contact portion 94B are located away from each other across the groove 92 in the axial direction of the rotor yoke 46. Specifically, the first contact portion 94A is arranged closer to the first axial end of the rotor yoke 46 than the groove 92 is in the axial direction of the rotor yoke 46, while the second contact portion 94B is arranged closer to the second axial end of the rotor yoke 46 than the groove 92 is in the axial direction of the rotor yoke 46. This layout of the first and second contact portions 94A and 94B minimizes tilting of the rotor yoke 46 toward the opposing portion 80, as compared with when the rotor yoke 46 has only one of the first contact portion 94A and the second contact portion 94B.

The opposing portion 80 is located outside the rotor yoke 46 in the radial direction of the rotor yoke 46, thereby enabling the volume of an inner space of the rotor 24 to be increased radially outward of the rotor 24, as compared to when the opposing portion 80 is located radially inside the rotor yoke 46.

The formation of the groove 92 in the outer peripheral surface 98 of the rotor yoke 46 ensures development of magnetic paths in portions of the rotor yoke 46 which are close to the inner peripheral surface 90 of the rotor yoke 46, thereby enhancing the magnetic characteristics of the motor 10.

FIG. 19 illustrates a modification of the structure of the rotor 24 in the fourth embodiment. The groove 92 has a portion overlapping portions of the rotor magnets 48 in the radial direction of the rotor yoke 46. This structure enables the size of the rotor 24 to be decreased in the axial direction thereof, as compared with when the groove 92 is totally offset from the rotor magnets 48 in the axial direction of the rotor yoke 46.

The formation of the groove 92 in the outer peripheral surface 98 of the rotor yoke 46 enables the bonding surface 90A of the rotor yoke 46 to be shaped to overlap the groove 92 in the radial direction of the rotor yoke 46, thereby resulting in an increased degree of freedom of layout of the rotor magnets 48 in the axial direction of the rotor yoke 46.

### Fifth Embodiment

The fifth embodiment in this disclosure will be described below.

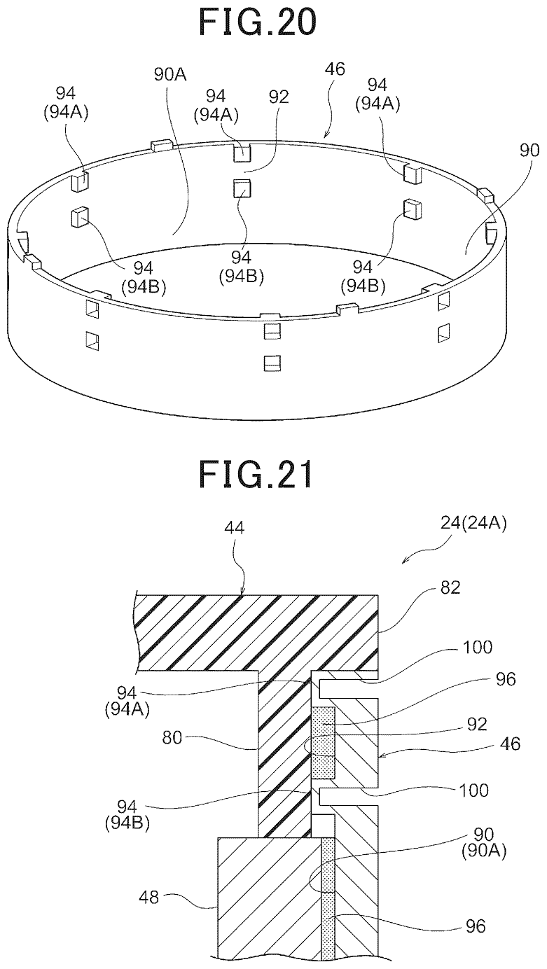

The fifth embodiment is different in configuration discussed below, from the first embodiment. FIG. 20 is a perspective view which illustrates the rotor yoke 46 according to the fifth embodiment. FIG. 21 is a schematic cross-sectional view, with dimensions of each component exaggerated, illustrating the portion 24A of the rotor 24 according to the fifth embodiment. The rotor yoke 46 in this embodiment includes pairs of contact portions 94. Each pair of the contact portions 94 includes the first contact portion 94A and the second contact portion 94B. Each of the first contact portions 94A and the second contact portions 94B is formed by a protrusion on the rotor yoke 46 which bulges radially inward. Such protrusions may be made using pressing techniques.

The formation of the first contact portions 94A and the second contact portions 94B using, for example a press, will cause the cavities 100 to appear in the rotor yoke 46 on back sides the first contact portions 94A and the second contact portions 94B. Specifically, the cavities 100 are formed in an outer peripheral surface of the rotor yoke 46 and open radially outward of the rotor yoke 46. The first contact portions 94A and the second contact portions 94B in the fourth embodiment are examples of protrusions of the rotor yoke 46 in this disclosure.

The first contact portions 94A are arranged at equal intervals away from each other on the inner peripheral surface 90 of the rotor yoke 46 in the circumferential direction of the rotor yoke 46. Similarly, the second contact portions 94B are arranged at equal intervals away from each other on the inner peripheral surface 90 of the rotor yoke 46 in the circumferential direction of the rotor yoke 46. The first contact portion 94A and the second contact portion 94B of each pair are aligned with each other in the axial direction of the rotor yoke 46. An array of the first contact portions 94A and an array of the second contact portions 94B, as can be seen in FIG. 21, define the groove 92 on the inner peripheral surface 90.

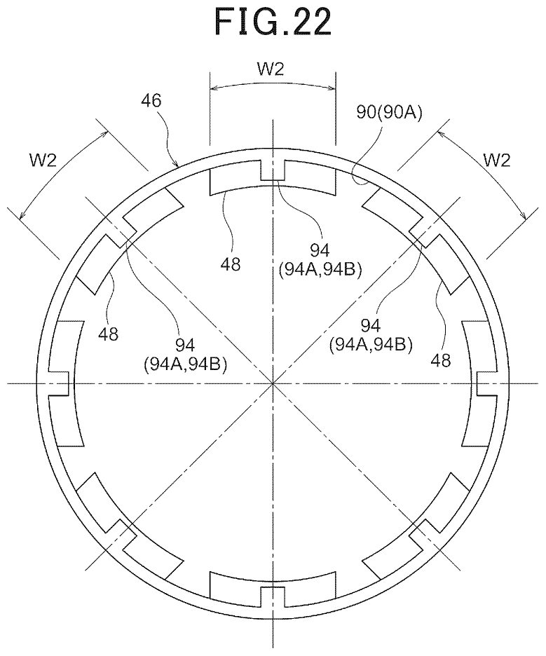

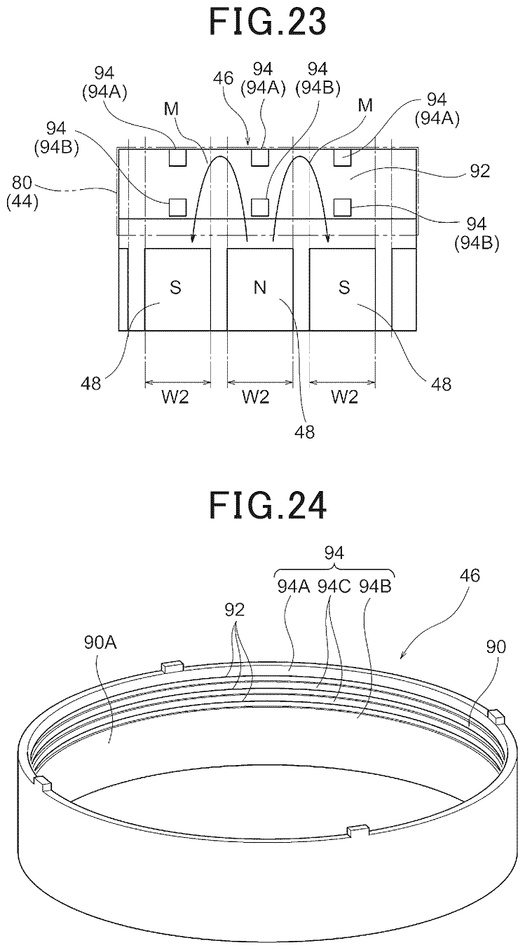

FIG. 22 is a plan view which illustrates the rotor yoke 46 having the rotor magnets 48 attached to the inner peripheral surface 90 thereof according to the fifth embodiment. FIG. 23 is an explanatory view which represents positional relation among the contact portions 94 of the rotor yoke 46, the groove 92 of the rotor yoke 46, and the rotor magnets 48. In FIG. 23, the contact portions 94, the rotor yoke 46, and the rotor magnets 48 are shown in a planarly developed state. Each of the contact portions 94 lines within the width range W2 defined by a width of a corresponding one of the rotor magnets 48, as measured in the circumferential direction of the rotor yoke 46. Each of the contact portions 94 is located outside the magnetic flux path M extending from one to the other of a respective adjacent two of the rotor magnets 48.

Each of the first contact portion 94A and the second contact portion 94B in this embodiment is formed by a portion of the rotor yoke 46 formed in the shape of a protrusion which bulges radially inward of the rotor yoke 46. A circumferential array of the first contact portions 94A and a circumferential array of the second contact portions 94B define the groove 92 therebetween on the inner peripheral surface 90 of the rotor yoke 46. The groove 92 may, therefore, be made by forming the first contact portions 94A and the second contact portions 94B on the inner peripheral surface 90 of the rotor yoke 46 using a press, not a cutting machine, which results in a production cost of the groove 92 being lower than that using the cutting machine.

Each of the contact portions 94 lines within the width range W2 defined by a width of a corresponding one of the rotor magnets 48, as measured in the circumferential direction of the rotor yoke 46. This minimizes forming each of the first contact portions 94A and the second contact portions 94B with the cavities 100 behind them inside a corresponding one of the magnetic flux paths M extending from one to the other of a respective adjacent two of the rotor magnets 48.

The above layout of the first contact portion 94A and the second contact portion 94B enhances magnetic characteristics of the motor 10 as compared with a case in which the first contact portions 94A and the second contact portions 94B are located in the magnetic flux paths M.

### Sixth Embodiment

The sixth embodiment will be described below.

The sixth embodiment is different in configuration discussed below, from the first embodiment. FIG. 24 is a perspective view which illustrates the rotor yoke 46 according to the sixth embodiment. The rotor yoke 46 in this embodiment has a plurality of grooves 92 formed therein. Each of the grooves 92 extends in an annular form in the circumferential direction of the rotor yoke 46. The grooves 92 are arranged adjacent to each other in the axial direction of the rotor yoke 46. The number of the grooves 92 may be selected as needed.

The contact portions 94 include the first contact portion 94A, the second contact portion 94B, and a plurality of third contact portions 94C. The first contact portion 94A is located outside a radially outermost one of the grooves 92 and closest to the first axial end of the rotor yoke 46. The second contact portion 94B is located outside a radially outermost one of the grooves 92 and closest to the second axial end of the rotor yoke 46. Each of the third contact portions 94C is located between adjacent two of the grooves 92.

The rotor yoke 46 in the sixth embodiment, as described above, has formed in the inner peripheral surface 90 the grooves 92 which are arranged adjacent to each other in the axial direction of the rotor yoke 46. This structure enables each of the grooves 92 to be shaped to have a decreased width, as compared with a case where the rotor yoke 46 has formed therein a single groove whose width is identical with a total of widths of the grooves 92 illustrated in FIG. 24, thereby resulting in an increased degree of rigidity of the rotor yoke 46.

Areas of the rotor yoke 46 between the adjacent grooves 92 define the third contact portions 94C. This minimizes a risk that the rotor yoke 46 may tilt or lean toward the opposing portion 80, as compared with when the contact portions 94 include only the first contact portion 94A and the second contact portion 94B.

### Seventh Embodiment

The seventh embodiment will be described below.

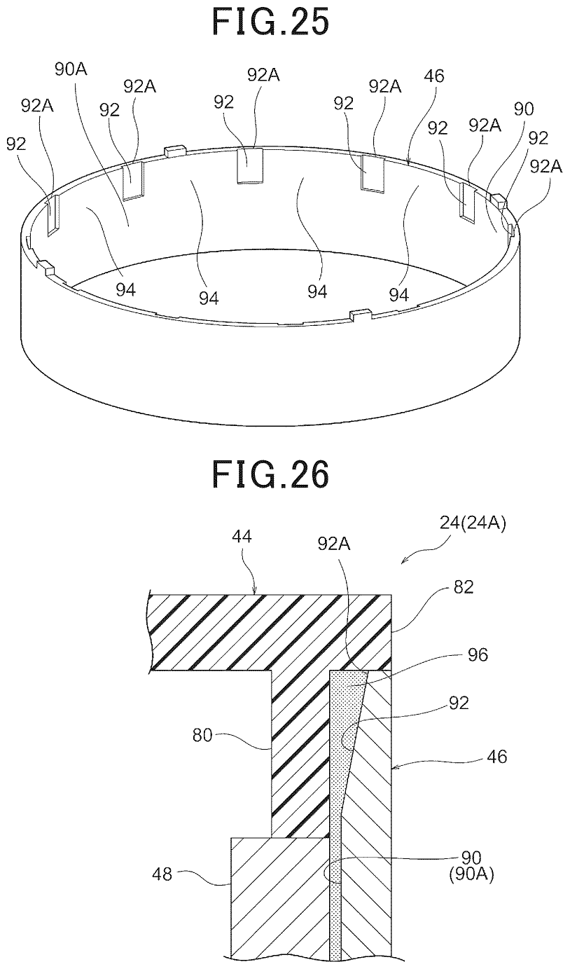

The seventh embodiment is different in configuration discussed below, from the third embodiment. FIG. 25 is a perspective view which illustrates the rotor yoke 46 according to the seventh embodiment. The rotor yoke 46 in this embodiment has a plurality of grooves 92 formed in the inner peripheral surface 90. The grooves 92 are identical in shape with each other and arranged at equal intervals away from each other in the circumferential direction of the rotor yoke 46. The number of the grooves 92 may be selected as needed.

Each of the grooves 92 has a length in the axial direction of the rotor yoke 46. Each of the groove 92 opens toward the first axial end of the rotor yoke 46. Specifically, each of the grooves 92 has the opening 92A facing in the first axial end of the rotor yoke 46. Each of the grooves 92 has a closed end facing in the second axial end of the rotor yoke 46. An area of the rotor yoke 46 between a respective adjacent two of the adjacent grooves 92 defines the contact portion 94.

The grooves 92 are, as described above, arranged adjacent to each other in the circumferential direction of the roto yoke 46, thereby resulting in increased thicknesses of portions of the rotor yoke 46 each of which is located between a respective adjacent two of the grooves 92. This enhances the rigidity of the rotor yoke 46, as compared with when the rotor yoke 46 has only a single groove extending in the circumferential direction thereof.

The grooves 92 are identical in configuration with each other and arranged at equal intervals away from each other in the circumferential direction of the rotor yoke 46. This enables the center of gravity of the rotor yoke 46 to coincide with the center of rotation of the rotor yoke 46, thereby ensuring rotational balance of the rotor 24.

An area of the rotor yoke 46 between a respective adjacent two of the grooves 92 defines the contact portion 94. Such layout of the contact portions 94, therefore, enables an area of contact between each of the contact portions 94 and the opposing portion 80 to be increased, as compared with when the rotor yoke 46 has only a single annular groove extending in the circumferential direction thereof. This results in an increased degree of rigidity of the rotor yoke 46 required to mechanically support the opposing portion 80. Each of the contact portions 94 between the adjacent grooves 92 also functions as a highly rigid element, thus resulting in an increase in entire rigidity of the rotor yoke 46, as compared to when the rotor yoke 46 has formed therein a single annular groove extending in the circumferential direction thereof. Mechanical contact of each of the contact portions 94 with the opposing portion 80 through the adhesive 96 also enhances the strength of joint of the rotor yoke 46 to the opposing portion 80.

Each of the grooves 92, as described above, has the opening 92A facing the first axial end of the rotor yoke 46, thereby facilitating formation of each of the grooves 92 in the inner peripheral surface 90 of the rotor yoke 46, as compared to when each of the grooves 92 is shaped to also have a closed end facing in the first axial end of the rotor yoke 46 without the opening 92A.

### Eighth Embodiment

The eighth embodiment in this disclosure will be described below.

The eighth embodiment is different in configuration discussed below, from the first embodiment. FIG. 26 is a schematic cross-sectional view, with dimensions of each component exaggerated, illustrating the portion 24A of the rotor 24 according to the eighth embodiment. The rotor 24 in this embodiment has formed therein the groove 92 which opens toward the first axial end of the rotor yoke 46. Specifically, the groove 92 has the opening 92A facing in the first axial end of the rotor yoke 46. The groove 92, as can be seen in FIG. 26, has a bottom wall which is inclined relative to the center axis of the rotor yoke 46 to have a depth decreasing from the first axial end toward the second axial end of the rotor yoke 46.

The inclination of the bottom of the groove 92 to have the depth decreasing from the first axial end to the second axial end of the rotor yoke 46 results in an increased thickness of a portion of the rotor yoke 46 which radially faces the rotor magnets 48, thereby enhancing the rigidity of the rotor yoke 46 required to mechanically support the rotor magnets 48, as compared with when the groove 92 is shaped to have a constant depth in the axial direction of the rotor yoke 46.

The above configuration of the groove 92 of the rotor yoke 46 results in increased thicknesses of portions of the rotor yoke 46 which radially face the rotor magnets 48 and create magnetic circuits, thereby ensuring required magnetic characteristics of the motor 10.

### Ninth Embodiment

The ninth embodiment in this disclosure will be described below.

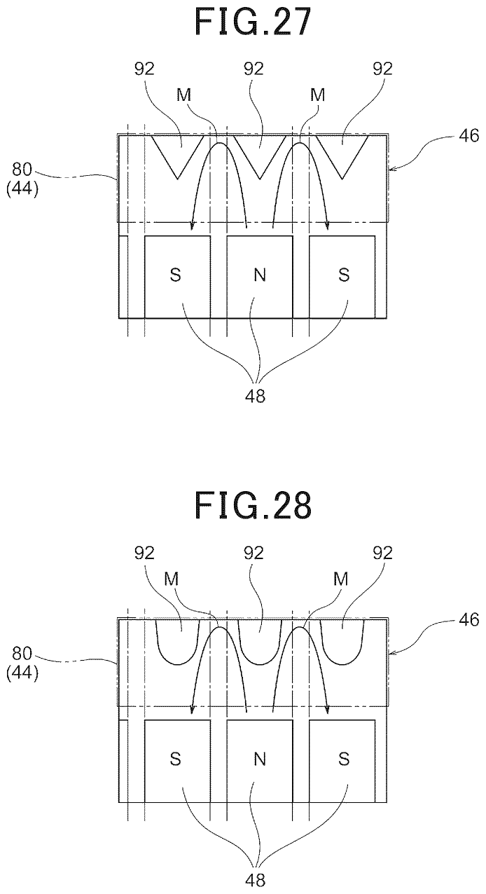

The ninth embodiment is different in configuration discussed below, from the third embodiment. FIG. 27 is an explanatory diagram which illustrates the positional relationship among the opposing portion 80 of the support member 44, the grooves 92 of the rotor yoke 46, and the plurality of rotor magnets 48 according to the ninth embodiment.

FIG. 27 illustrates the opposing portion 80, the rotor yoke 46, and the plurality of rotor magnets 48 in a planar developed view. Each of the grooves 92 tapers toward a corresponding one of the rotor magnets 48 to have a width, as measured in the circumferential direction of the rotor yoke 46, which decreases the rotor magnet 48. In other words, each of the grooves 92 is of a triangular shape, as viewed from radially inside the rotor yoke 46. Each of the grooves 92, therefore, has an edge-shaped portion close to a corresponding one of the rotor magnets 48. The tapered shape of the grooves 92 is defined so that each of the grooves 92 lies outside the magnetic flux path M extending from one to the other of a respective adjacent two of the rotor magnets 48.

Each of the grooves 92 in the ninth embodiment is, as described above, located outside a corresponding one of the magnetic flux paths M each extending from one to the other of a respective adjacent two of the rotor magnets 48, thereby eliminating a risk that thin-walled portions of the rotor yoke 46 which are created by formation of the grooves 92 may overlap the magnetic flux paths M. This ensures required thicknesses of portions of the rotor yoke 46 through which the magnetic flux paths M pass, as compared with the thin-walled portions of the rotor yoke 46 lie in the magnetic flux paths M.

Each of the grooves 92, as described above, shaped to taper toward a corresponding one of the rotor magnets 48 to have a width, as measured in the circumferential direction of the rotor yoke 46, which decreases the rotor magnet 48. This also minimizes a risk that thin-walled portions of the rotor yoke 46 which are created by formation of the grooves 92 may lie in the magnetic flux paths M. This ensures required magnetic characteristics of the motor 10. The tapered shape of the grooves 92 also ensures a required dimension of the grooves 92 in the axial direction of the rotor yoke 46 as well as elimination of the risk that the thin-walled portions of the rotor yoke 46 which are created by formation of the grooves 92 may lie in the magnetic flux paths M. This also ensures a required volume of the adhesive 96, thereby enhancing the mechanical strength of joint of the rotor yoke 46 to the opposing portion 80 of the support member 44.

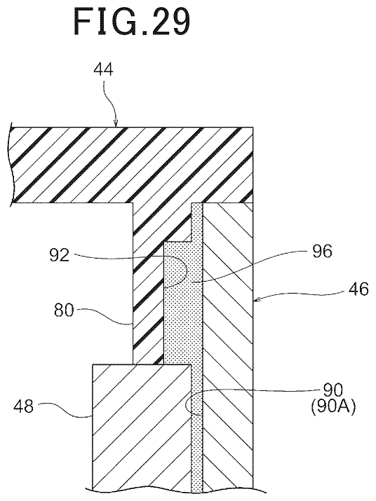

FIG. 28 illustrates a modification of the grooves 92 according to the ninth embodiment. In this modification, each of the grooves 92 is of a semicircular or semi-ellipse shape, as viewed from inside the rotor yoke 46. In other words, each of the grooves 92 is shaped to have an arc end facing a corresponding one of the rotor magnets 48. This structure also offers substantially the same beneficial advantages as those in the above embodiments.

It should be noted that this disclosure includes all possible combinations of the features of the above embodiments, features similar to or equivalents of the parts of the above embodiments, or modifications of the above embodiments.

This disclosure has referred to the above embodiments, but however, it is not limited to the above embodiments, but may be realized by various embodiments without departing from the purpose of the disclosure.

As apparent from the above discussion, this disclosure provides the following unique structures.

### First Aspect

A motor (10) comprises: (a) a shaft (32); (b) a stator (22) which is arranged coaxially with the shaft; (c) a rotor yoke (46) which is disposed around the stator; and (d) a support member (44) which mechanically supports the rotor yoke to the shaft. The support member includes an opposing portion (80) which faces the rotor yoke in a radial direction of the rotor yoke. The rotor yoke has an opposing surface (90, 98) which faces the opposing portion of the support member and has formed therein a groove (92) in which adhesive (96) is disposed to bond the opposing portion and the opposing surface together.

### Second Aspect

The motor as set forth in the above first aspect, wherein the opposing surface of the rotor yoke has rotor magnets (48) attached thereto, and the groove is offset from the rotor magnets in an axial direction of the rotor yoke.

### Third Aspect

The motor as set forth in the above first or second aspect, wherein the groove lies in a range defined by a dimension of the opposing portion, as measured in an axial direction of the support member.

### Fourth Aspect

The motor as set forth in any one of the first to third aspects, wherein the groove is of an annular shape extending in a circumferential direction of the roto yoke.

### Fifth Aspect

The motor as set forth in the first aspect, wherein the rotor yoke has the rotor magnets attached to a surface thereof which faces away from the opposing surface, and a portion of the groove and portions of the rotor magnets overlap each other in a radial direction of the rotor yoke.

### Sixth Aspect

The motor as set forth in any one of the first to fifth aspects, wherein the groove includes a plurality of grooves which are formed in the opposing surface and arranged adjacent to each other in the axial direction of the rotor yoke.

### Seventh Aspect

The motor as set forth in any one of the first to third aspects, wherein the groove includes a plurality of grooves which are formed in the opposing surface and arranged adjacent to each other in a circumferential direction of the rotor yoke.

### Eighth Aspect

The motor as set forth in the seventh aspect, wherein the rotor magnets are disposed on the opposing surface and arranged in the circumferential direction of the rotor yoke, and each of the grooves lies in a range defined by a width of a corresponding one of the rotor magnets, as measured in the circumferential direction of the rotor yoke.

### Ninth Aspect

The motor as set forth in the seventh or eighth aspect, wherein the rotor magnets are disposed on the opposing surface and arranged in the circumferential direction of the rotor yoke, and an area of the opposing surface between a respective adjacent two of the grooves lies in a magnetic flux path extending from one to the other of a corresponding adjacent two of the rotor magnets.

### Tenth Aspect

The motor as set forth in any one of the seventh to ninth aspects, wherein each of the grooves has an opening facing in a first axial side that is one of axially opposed sides of the rotor yoke.

### Eleventh Aspect

The motor as set forth in any one of the seventh to tenth aspects, wherein the opposing surface has the rotor magnets disposed thereon, the grooves are offset from the rotor magnets in the axial direction of the rotor yoke, and each of the grooves is of a tapered shape with a width, as measured in the circumferential direction of the rotor yoke, which decreases toward a corresponding one of the rotor magnets.

### Twelfth Aspect

The motor as set forth in any one of the seventh to eleventh aspects, wherein the opposing surface disposed thereon the rotor magnets which are arranged adjacent to each other in the circumferential direction of the rotor yoke, and each of the grooves lies outside a magnetic flux path extending from one to the other of a corresponding adjacent two of the rotor magnets.

### Thirteenth Aspect

The motor as set forth in any one of the first to eleventh aspects, wherein the opposing surface has contact portions (94) each of which makes a mechanical contact with the opposing portion in the radial direction of the rotor yoke.

### Fourteenth Aspect

The motor as set forth in the thirteenth aspect, wherein the contact portions are offset from the groove in the axial direction of the rotor yoke.

### Fifteenth Aspect

The motor set froth in the thirteenth to fourteenth aspect, wherein the opposing surface has the rotor magnets disposed thereon, and the contact portions are offset from the rotor magnets in the axial direction of the rotor yoke.

### Sixteenth Aspect

The motor as set forth in any one of the thirteenth to fifteenth aspects, wherein the contact portions include a first contact portion and a second contact portion. The first contact portion is located closer to a first axial side of the rotor yoke than the groove is. The second contact portion is located closer to a second axial side of the rotor yoke than the groove is. The second axal side is opposed to the first axial side in the axial direction of the rotor yoke.

### Seventeenth Aspect

The motor as set forth in any one of the thirteenth to sixteenth aspects, wherein each of the contact portions is of an annular shape extending in a circumferential direction of the rotor yoke.

### Eighteenth Aspect

The motor as set forth in any one of the thirteenth to sixteenth aspects, wherein the opposing surface has the plurality of rotor magnets arranged adjacent to each other in the circumferential direction of the rotor yoke, the opposing surface has the plurality of contact portions arranged adjacent to each other in the circumferential direction of the roto yoke, and each of the contact portions extends over a range that is defined by an interval between a respective adjacent two of the rotor magnets.

### Nineteenth Aspect

The motor as set forth in the eighteenth aspect, wherein each of the contact portions lies in a magnetic flux path extending from one to other of a respective adjacent two of the rotor magnets.

### Twentieth Aspect

The motor as set forth in any one of the thirteenth to sixteenth aspects, wherein the opposing surface has the plurality of contact portions arranged adjacent to each other in the circumferential direction of the rotor yoke, and the groove includes a plurality of grooves each of which has an opening facing the first axial side of the rotor yoke between a respective adjacent two of the contact portions.

### Twenty-First Aspect

The motor as set forth in any one of the thirteenth to sixteenth aspects, wherein the groove includes a plurality of grooves arranged adjacent to each other in the circumferential direction of the rotor yoke on the opposing surface, and each of the contact portions lies in an area of the opposing surface between a respective adjacent two of the grooves.

### Twenty-Second Aspect

The motor as set forth in any one of the thirteenth to sixteenth aspects, wherein each of the contact portions is defined by a portion of the rotor yoke formed in a shape of a protrusion which bulges in the radial direction of the rotor yoke.

### Twenty-Third Aspect

The motor as set forth in the twenty-second aspect, wherein the opposing surface has the plurality of rotor magnets arranged adjacent to each other in the circumferential direction of the rotor yoke, the opposing surface has the protrusions arranged adjacent to each other in the circumferential direction of the rotor yoke, and each of the protrusions lies in a range of a width of a corresponding one of the rotor magnets, as measured in the circumferential direction of the rotor yoke.

### Twenty-Fourth Aspect

The motor as set forth in any one of the first to twenty-third aspects, wherein the opposing portion is located radially inward of the rotor yoke, and the opposing surface is defined by an inner peripheral surface (90) of the rotor yoke.

### Twenty-Fifth Aspect

The motor as set forth in any one of the first to twenty-third aspects, wherein the opposing portion is located radially outside the rotor yoke, and the opposing surface is defined by an outer peripheral surface (98) of the rotor yoke.

What is claimed is:

1. A motor comprising:
a shaft;
a stator which is arranged coaxially with the shaft;
a rotor yoke which is disposed around the stator; and
a support member which mechanically supports the rotor yoke to the shaft, wherein
the support member includes an opposing portion which faces the rotor yoke in a radial direction of the rotor yoke,
the rotor yoke has an opposing surface which faces the opposing portion of the support member and has formed therein a groove in which adhesive is disposed to bond the opposing portion and the opposing surface together,
the opposing surface of the rotor yoke has rotor magnets attached thereto, and
the groove is offset from the rotor magnets in an axial direction of the rotor yoke.

2. The motor as set forth in claim 1, wherein the groove lies in a range defined by a dimension of the opposing portion, as measured in an axial direction of the support member.

3. The motor as set forth in claim 1, wherein the groove is of an annular shape extending in a circumferential direction of the roto yoke.

4. The motor as set forth in claim 1, wherein the rotor yoke has the rotor magnets attached to a surface thereof which faces away from the opposing surface,
a portion of the groove and portions of the rotor magnets overlap each other in a radial direction of the rotor yoke.

5. The motor as set forth in claim 1, wherein the groove includes a plurality of grooves which are formed in the opposing surface and arranged adjacent to each other in the axial direction of the rotor yoke.

6. The motor as set forth in claim 1, wherein the groove includes a plurality of grooves which are formed in the opposing surface and arranged adjacent to each other in a circumferential direction of the rotor yoke.

7. The motor as set forth in claim 6, wherein the rotor magnets are disposed on the opposing surface and arranged in the circumferential direction of the rotor yoke,
each of the grooves lies in a range defined by a width of a corresponding one of the rotor magnets, as measured in the circumferential direction of the rotor yoke.

8. The motor as set forth in claim 6, wherein the rotor magnets are disposed on the opposing surface and arranged in the circumferential direction of the rotor yoke,
an area of the opposing surface between a respective adjacent two of the grooves lies in a magnetic flux path extending from one to the other of a corresponding adjacent two of the rotor magnets.

9. The motor as set forth in claim 6, wherein each of the grooves has an opening facing in a first axial side that is one of axially opposed sides of the rotor yoke.

10. The motor as set forth in claim 6, wherein the opposing surface has the rotor magnets disposed thereon,
the grooves are offset from the rotor magnets in the axial direction of the rotor yoke,
each of the grooves is of a tapered shape with a width, as measured in the circumferential direction of the rotor yoke, which decreases toward a corresponding one of the rotor magnets.

11. The motor as set forth in claim 6, wherein the opposing surface disposed thereon the rotor magnets which are arranged adjacent to each other in the circumferential direction of the rotor yoke,
each of the grooves lies outside a magnetic flux path extending from one to the other of a corresponding adjacent two of the rotor magnets.

12. The motor as set forth in claim 1, wherein the opposing surface has contact portions each of which makes a mechanical contact with the opposing portion in the radial direction of the rotor yoke.

13. The motor as set forth in claim 12, wherein the contact portions are offset from the groove in the axial direction of the rotor yoke.

14. The motor as set forth in claim 12, wherein the opposing surface has the rotor magnets disposed thereon,
the contact portions are offset from the rotor magnets in the axial direction of the rotor yoke.

15. The motor as set forth in claim 12, wherein the contact portions include a first contact portion and a second contact portion, the first contact portion being located closer to a first axial side of the rotor yoke than the groove is, the second contact portion being located closer to a second axial side of the rotor yoke than the groove is, the second axal side being opposed to the first axial side in the axial direction of the rotor yoke.

16. The motor as set forth in claim 12, wherein each of the contact portions is of an annular shape extending in a circumferential direction of the rotor yoke.

17. The motor as set forth in claim 12, wherein the opposing surface has the plurality of rotor magnets arranged adjacent to each other in the circumferential direction of the rotor yoke,
the opposing surface has the plurality of contact portions arranged adjacent to each other in the circumferential direction of the roto yoke,
each of the contact portions extends over a range that is defined by an interval between a respective adjacent two of the rotor magnets.

18. The motor as set forth in claim 17, wherein each of the contact portions lies in a magnetic flux path extending from one to other of a respective adjacent two of the rotor magnets.

19. The motor as set forth in claim 12, wherein the opposing surface has the plurality of contact portions arranged adjacent to each other in the circumferential direction of the rotor yoke, and
the groove includes a plurality of grooves each of which has an opening facing the first axial side of the rotor yoke between a respective adjacent two of the contact portions.

20. The motor as set forth in claim 12, wherein the groove includes a plurality of grooves arranged adjacent to each other in the circumferential direction of the rotor yoke on the opposing surface, and
each of the contact portions lies in an area of the opposing surface between a respective adjacent two of the grooves.

21. The motor as set forth in claim 12, wherein each of the contact portions is defined by a portion of the rotor yoke formed in a shape of a protrusion which bulges in the radial direction of the rotor yoke.

22. The motor as set forth in claim 21, wherein the opposing surface has the plurality of rotor magnets arranged adjacent to each other in the circumferential direction of the rotor yoke,
the opposing surface has the protrusions arranged adjacent to each other in the circumferential direction of the rotor yoke,
each of the protrusions lies in a range of a width of a corresponding one of the rotor magnets, as measured in the circumferential direction of the rotor yoke.

23. The motor as set forth in claim 1, wherein the opposing portion is located radially inward of the rotor yoke,
the opposing surface is defined by an inner peripheral surface of the rotor yoke.

24. The motor as set forth in claim 1, wherein the opposing portion is located radially outside the rotor yoke, and
the opposing surface is defined by an outer peripheral surface of the rotor yoke.
